(19) United States
(12) Patent Application Publication
(10) Pub. No.: US 2004/0257345 A1
(43) Pub. Date: Dec. 23, 2004

(54) Electronic apparatus with pointing device

(75) Inventors: Hitomi Makanae, Ome-shi (JP); Nobuyuki Hosoya, Ome-shi (JP); Shigeharu Imamura, Ome-shi (JP)

Correspondence Address: Finnegan, Henderson, Farabow,, Garrett & Dunner, L.L.P., 1300 I Street, N.W., Washington, DC, 20005-3315, US

(73) Assignee: KABUSHIKI KAISHA TOSHIBA

(21) Appl. No.: 10/773,259

(22) Filed: Feb. 9, 2004

(30) Foreign Application Priority Data
Jun. 20, 2003 (JP) 2003-177075

(51) Int. Cl. G09G 5/00

(52) U.S. Cl. 345/174

(57) ABSTRACT

An electronic apparatus includes a housing having an outer wall, a pointing device having a flat input surface, and an operation-area indicating sheet. The pointing device is contained in the housing such that the input surface is placed on the inner surface of the outer wall of the housing. The operation-area indicating sheet is removably provided on the outer surface of the outer wall of the housing at a position corresponding to at least part of the input surface of the pointing device.

### CROSS-REFERENCE TO RELATED APPLICATIONS

This application is based upon and claims the benefit of priority from the prior Japanese Patent Application No. 2003-177075, filed Jun. 20, 2003, the entire contents of which are incorporated herein by reference.

### BACKGROUND OF THE INVENTION

1. Field of the Invention

The present invention relates to an electronic apparatus, such as a portable computer, provided with a pointing device having a flat input surface.

2. Description of the Related Art

Among the portable computers referred to as notebooks, a type of portable computer contains a pointing device having a flat input surface in the housing. A pointing device that includes an input sheet, which detects capacitance, and a drive unit electrically connected to the input sheet, is known.

Sometimes, such a pointing device is contained in the housing such that the input surface of the input sheet is placed on the inner surface of the housing at a position corresponding to the palm rest. However, if a pointing device is contained in the housing in the above-described manner, the position of the input surface cannot be identified from the outside of the housing. Hence, in such a portable computer, an operation area is provided to the outer surface of the outer wall of the housing at a position corresponding to the input surface of the pointing device.

Some users desire that the housing of a portable computer have an original part in accordance with their liking. However, the color of and pattern on the housing of a conventional portable computer are decided at the time of manufacture and cannot be changed later on.

### BRIEF SUMMARY OF THE INVENTION

An electronic apparatus according to an embodiment of the present invention comprises: a housing having an outer wall; a pointing device having a flat input surface and contained in the housing such that the input surface is placed on an inner surface of the outer wall of the housing; and an operation-area indicating sheet removably provided on an outer surface of the outer wall of the housing at a position corresponding to at least part of the input surface of the pointing device.

### BRIEF DESCRIPTION OF THE SEVERAL VIEWS OF THE DRAWING

FIG. 1 is a perspective view showing a portable computer according to a first embodiment of the present invention;

FIG. 2 is a side view showing part of the housing of the portable computer of FIG. 1, with a housing partially cut away;

FIG. 3 is a front view showing the operation-area indicating sheet, and the neighborhood of the operation-area indicating sheet, of the portable computer of FIG. 1;

FIG. 4 is a section view along the IV-IV line shown in FIG. 3;

FIG. 5 is a front view showing the operation-area indicating sheet, and the neighborhood of the operation-area indicating sheet, of a portable computer according to a second embodiment of the present invention;

FIG. 6 is a section view along the VI-VI line shown in FIG. 5;

FIG. 7 is a section view showing the operation-area-indicating sheet, and the neighborhood of the operation-area indicating sheet, of another portable computer according to the second embodiment of the present invention; and

FIG. 8 is a section view showing the operation-area indicating sheet, and the neighborhood of the operation-area indicating sheet, of yet another portable computer according to the second embodiment of the present invention.

### DETAILED DESCRIPTION OF THE INVENTION

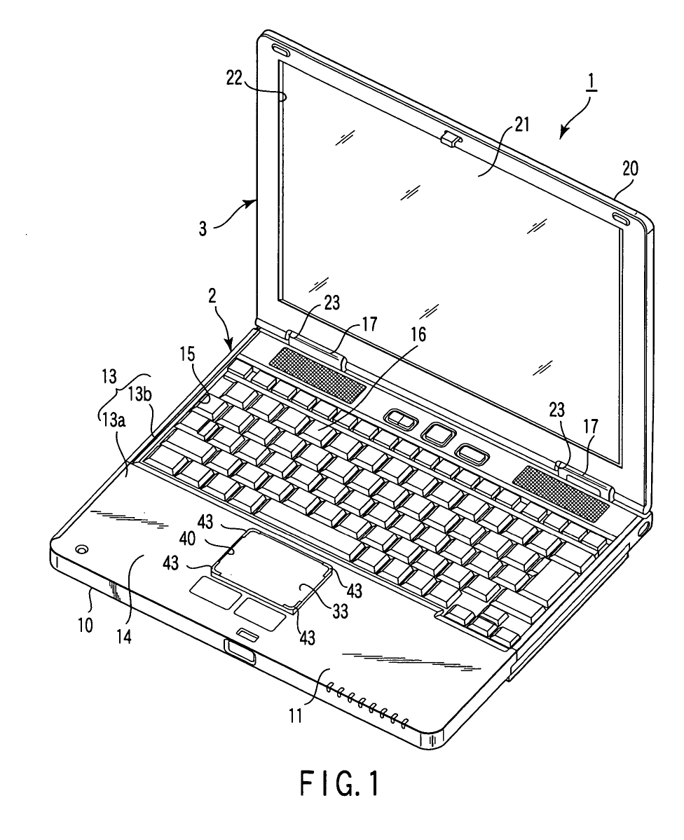

A first embodiment of the present invention will now be described with reference to FIGS. 1 to 4, wherein the present invention is applied to a portable computer, as the electronic apparatus. FIG. 1 discloses a notebook portable computer 1. The portable computer 1 comprises a main unit 2 and a liquid crystal display unit 3.

The main unit 2 has an opaque, resinous housing 10. The housing 10 has a case 12 and a cover 13, and is formed into a flat, box-like shape. In other words, the outer wall 11 of the housing 10 is formed with the case 12 and the cover 13. The outer wall 11 has an outer surface 11a exposed to the outside of the housing 10, and an inner surface 11b facing inward of the housing 10.

The cover 13 has a first cover 13a and a second cover 13b. Of the outer surface 11a of the outer wall 11 of the housing 10, the outer surface 11a of the first cover 13a has a palm rest 14. The second cover 13b is placed behind the first cover 13a. The second cover 13b has a keyboard mounting portion 15. A keyboard 16 is mounted to the keyboard mounting portion 15. A pair of legs 17 for supporting the display unit is provided to the rear end portion of the second cover 13b, and the legs 17 are spaced apart from each other in the width direction of the housing 10. In this embodiment, the cover 13 is made up of more than one member (the first cover 13a and the second cover 13b); however, the cover 13 may be made up of just one member.

The liquid crystal display unit 3 comprises a display housing 20, and a liquid crystal display panel 21 contained in the display housing 20. An opening 22 for display is provided in the front wall of the display housing 20. The opening 22 occupies a majority of the front wall. The display screen of the liquid crystal display panel 21 is exposed to the outside of the display housing 20 through the opening 22.

The display housing 20 has a pair of coupler depressed-portions 23 at one end portion thereof (the lower end portion in FIG. 1). Each of the coupler depressed-portions 23 comprises a depression opening frontward, downward and rearward of the display housing 20. The coupler depressed-portions 23 are spaced apart from each other in the width direction of the display housing 20 and respectively extend to the legs 17 of the housing 10. The coupler depressed-portions 23 are respectively turnably-supported by the legs 17, which are provided to the rear end portion of the housing 10, via hinge members (not shown).

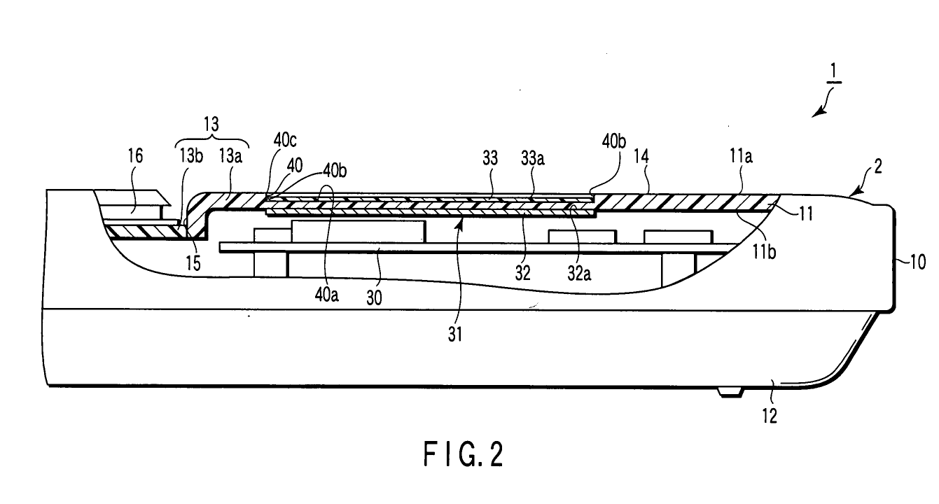

Consequently, the liquid crystal display unit 3 is turnable between a closed position in which the liquid crystal display 3 is laid down so as to cover the palm rest 14 and the keyboard 16 from above, and an open position in which the liquid crystal display 3 is stood up so as to expose the palm rest 14 and the keyboard 16. FIGS. 1 and 2 show the portable computer 1 in the open position.

As shown in FIG. 2, a printed wiring board 30, a pointing device 31 as an input device, a HDD (not shown), etc., are contained in the housing 10. The printed wiring board 30 and the HDD are secured to the case 12 of the housing 10 with screws. The pointing device 31 has an input sheet 32 and a drive unit (not shown). The input sheet 32 is, for example, a sheet that detects capacitance, and the surface on one side of the input sheet 32 is a flat input surface 32a. The drive unit is electrically connected to the input sheet 32.

The pointing device 31 is contained in the housing 10 such that the input surface 32a is placed on the inner surface 11b of the outer wall 11. In the embodiment, the input surface 32a of the pointing device 31 is stuck to a substantially central portion of the inner surface 11b of the first cover 13a.

Because the pointing device 31 is contained in the opaque, resinous housing 10, the position of the input surface 32a cannot be identified (visually identified) from the outside of the housing 10. Hence, in the portable computer 1, an operation-area indicating sheet 33 is removably provided to the outer surface 11a of the outer wall 11 of the housing 10 at a position corresponding to at least part of the input surface 32a of the pointing device 31, preferably at a position corresponding to substantially the entire input surface 32a. The operation-area indicating sheet 33 indicates the operation area for operating the pointing device 31. The exposed surface 33a exposed to the outside of the operation-area indicating sheet 33 is the operation area of the pointing device 31.

In the portable computer 1, because the input sheet 32 is provided on a substantially central portion of the inner surface 11b of the first cover 13a, the operation-area indicating sheet 33 will be provided to a substantially central portion of the palm rest 14, which is provided to the outer surface 11a of the first cover 13a. For example, a flexible sheet member, such as a soft rubber sheet, with a slightly sticky material applied to the back can be used as the operation-area indicating sheet 33.

The operation-area indicating sheet 33 can be made with materials of various colors. Alternatively, the exposed surface 33a of the operation-area indicating sheet 33 may be colored. In such cases, a user can select an operation-area indicating sheet 33 having an exposed surface 33a of a desired color, and hence, give the housing 10 an original operation area that is in accordance with the user's liking. Moreover, by making the color of the exposed surface 33a of the operation-area indicating sheet 33 different from the color of the outer surface 11a of the outer wall 11, the visibility of the operation area can be improved. Further, the exposed surface 33a of the operation-area indicating sheet 33 can be decorated with a desired pattern. In this way, too, a user can give the housing an original operation area that is in accordance with the user's liking.

The operation-area indicating sheet 33 may be simply stuck to the flat palm rest 14; however, in the embodiment, the operation-area indicating sheet 33 is provided to the palm rest 14 in the following way.

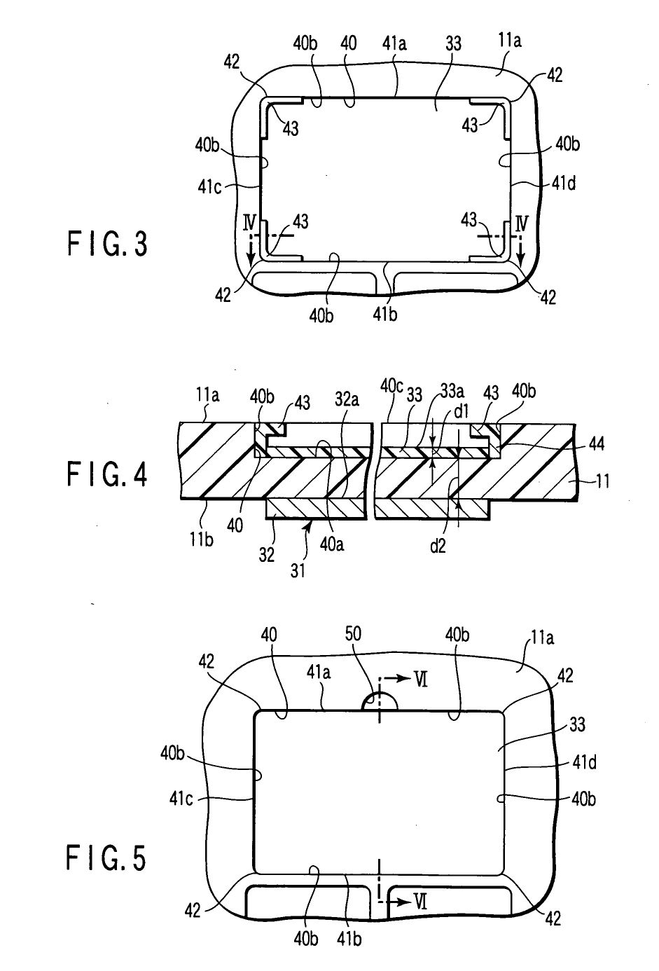

As shown in FIGS. 1 to 4, the palm rest 14 provided to the outer surface 11a of the first cover 13a has a sheet-containment depressed portion 40 at a position corresponding to at least part of the input surface 32a of the pointing device 31. In the embodiment, the palm rest 14 has a sheet-containment depressed portion 40 at a position corresponding to the whole area of the input surface 32a. The sheet-containment depressed portion 40 has a base 40a and a peripheral surface 40b rising from the perimeter of the base 40a. As shown in FIG. 3, the base 40a of the sheet-containment depressed portion 40 has, for example, four sides 41a, 41b, 41c, 41d and four corner portions 42, and is formed into a substantially quadrangle shape. The four corner portions 42 are round corners. The operation-area indicating sheet 33 is removably stuck to the base 40a of the sheet-containment depressed portion 40.

In the embodiment, the thickness d1 of the operation-area indicating sheet 33 is 0.3 mm, and the thickness between the base 40a of the sheet-containment depressed portion 40 and the inner surface 11b of the housing 10 is 1.2 mm. Therefore, the distance between the operation area (the exposed surface 33a of the operation-area indicating sheet 33) and the input surface 32a is 1.5 mm. Hence, the sensitivity of the pointing device 31 is set on the assumption that the pointing device 31 will be operated from a position 1.5 mm away from the input surface 32.

As shown in FIGS. 3 and 4, in the embodiment, in order to reduce the chances of the operation-area indicating sheet 33 being accidentally peeled off and fallen off the sheet-containment depressed portion 40, an overhang edge portion 43 is provided at the opening end 40c of the sheet-containment depressed portion 40. The overhang edge portion 43 overhangs to cover at least part of the perimeter portion of the operation-area indicating sheet 33. In the embodiment, four overhang edge portions 43 are provided, for example, at the positions corresponding to the four corner portions 42 of the sheet-containment depressed portion 40. The overhang edge portion 43 may be provided at a position corresponding to at least part of the sides 41a, 41b, 41c, 41d of the sheet-containment depressed portion 40. Alternatively, the overhang edge portion 43 may be provided to correspond to the entire perimeter of the sheet-containment depressed portion 40.

As shown in FIG. 4, the overhang edge portion 43 can be provided to the frame 44 that is fit into the sheet-containment depressed portion 40. In other words, the overhang edge portion 43 can be provided at the opening end 40c of the sheet-containment depressed portion 40 by providing the overhang edge portion 43 to the upper end edge of the frame 44 and fitting the frame 44 into the sheet-containment depressed portion 40.

The operation-area indicating sheet 33 of the portable computer 1 of the embodiment is replaced with a new one in the following manner.

First, the operation-area indicating sheet 33 that has been stuck to the base 40a of the sheet-containment depressed portion 40 until now is peeled off. It is only necessary to bend the operation-area indicating sheet 33 avoiding the overhang edge portions 43 provided at the corner portions 42 to peel off the operation-area indicating sheet 33.

A user individually selects a new operation-area indicating sheet 33 having a desired color and pattern. Then, the user bends the new operation-area indicating sheet 33 avoiding the overhang edge portions 43 provided at the corner portions 42, as done at the time of removing, and puts the new operation-area indicating sheet 33 into the sheet-containment depressed portion 40 (between the overhang edge portions 43 and the base 40a). After that, the user sticks the operation-area indicating sheet 33 to the base 40a of the sheet-containment depressed portion 40. By the above movements, the operation-area indicating sheet 33 can be replaced with a new one.

As described above, the portable computer 1 of the embodiment is provided with an operation-area indicating sheet 33 for indicating the operation area. The operation-area indicating sheet 3 is provided on the outer surface 11a, which is exposed to the outside of the housing 10, at a position corresponding to at least part of the pointing device 31. Hence, even if the pointing device 31 is contained in the housing 10 such that the input surface 32a is placed on the inner surface 11b of the housing 10, the position of the input surface 32a can be easily identified from the outside of the housing 10, and consequently, it is easy to operate.

Moreover, because the operation-area indicating sheet 33 is removably provided to the outer surface 11a of the housing 10, replacement is easy. Hence, a user can replace the operation-area indicating sheet 33 with a new one at will. Therefore, if a user has two or more operation-area indicating sheets 33 having various colors and patterns, the user can give the operation area of the pointing device 31, which is part of the outer surface 11a of the housing 10, a desired color and pattern. In this fashion, according to the portable computer 1 of the embodiment, the housing 10 can have a part that is original to a user by simply replacing the operation-area indicating sheet 33 with a different one.

When operating the pointing device 31, normally, the pointer is manipulated by the stroke-like touch of a fingertip on the operation area. Therefore, there are times when the operation area becomes dirty. In the embodiment, because the operation area is the exposed surface 33a of the operation-area indicating sheet 33, even if the operation area becomes dirty, the operation area can be cleaned by simply replacing the operation-area indicating sheet 33 with a new one. Therefore, there is another advantage; the operation area can be kept clean.

In the embodiment, a sheet-containment depressed portion 40 is provided at a position corresponding to at least part of the input surface 32a of the pointing device 31. The sheet-containment depressed portion 40 has a base 40a and a peripheral surface 40b rising from the perimeter of the base 40a. The operation-area indicating sheet 33 is removably stuck to the base 40b of the sheet-containment depressed portion 40. Therefore, the operation-area indicating sheet 33 does not stick out above the outer surface 11a of the housing 10. Moreover, when replacing the operation-area indicating sheet 33 with a new one, positioning is easy.

In the embodiment, an overhang edge portion 43 is provided at the opening end 40c of the sheet-containment depressed portion 40 to cover at least part of the perimeter portion of the operation-area indicating sheet 33. Therefore, even in the event that the operation-area indicating sheet 33 is peeled off the base 40a of the sheet-containment depressed portion 40, the chances of the operation-area indicating sheet 33 being accidentally fallen off the sheet-containment depressed portion 40 can be reduced.

Moreover, the base 40a of the sheet-containment depressed portion 40 has four corner portions 42, and four overhang edge portions 43 are provided at the positions corresponding to the four corner portions 42, respectively. Therefore, not only can the chances of the operation-area indicating sheet 33 being accidentally fallen off the sheet-containment depressed portion 40 be very much reduced, but also the overhang edge portions 43 are not likely to get in the way during the operation of the pointing device 31.

Moreover, the operation-area indicating sheet 33 is flexible, and hence, even if the overhang edge portions 43 are provided, the operation-area indicating sheet 33 can be peeled off by bending, avoiding the overhang edge portions 43. Therefore, the operation-area indicating sheet 33 is easy to peel off.

The housing 10 has a frame 44 that fits into the sheet-containment depressed portion 40 along the peripheral surface 40b of the sheet-containment depressed portion 40, and the overhang edge portions 43 are provided to the frame 44. In this way, the overhang edge portions 43 can be easily provided at the opening end 40c of the sheet-containment depressed portion 40.

A second embodiment of the present invention will now be described with references to FIGS. 5 to 8.

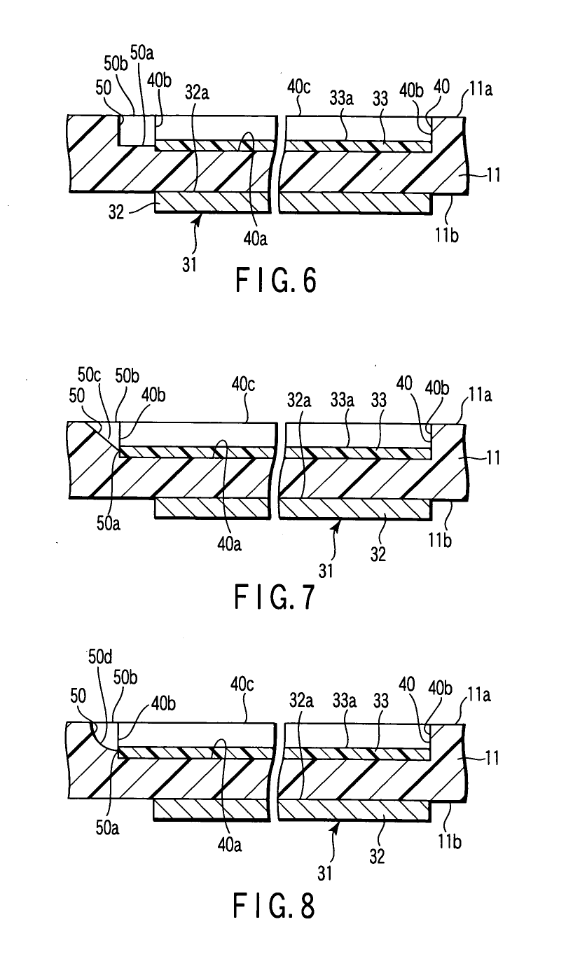

The outer surface 11a of the housing 10 of this portable computer 1 has a finger recess 50 at a position corresponding to the sheet-containment depressed portion 40, as shown in FIGS. 5 and 6. The finger recess 50 is a depression that allows a user to put his finger on the edge of the operation-area indicating sheet 33 at the time of peeling off the operation-area indicating sheet 33. In the embodiment, among the four sides 41a, 41b, 41c, 41d of the sheet-containment depressed portion 40, the finger recess 50 is provided, for example, at a substantially middle portion of the side 41a facing the keyboard 16.

The base 50a of the finger recess 50 is situated at a lower level than the exposed surface 33a of the operation-area indicating sheet 33 to allow the user to put his finger on the edge of the operation-area indicating sheet 33 at the time the user puts his finger into the finger recess 50.

The opening end 50b of the finger recess 50 is shaped, for example, substantially semicircular. In this way, it is easy for a user to put his finger into the finger recess 50.

The finger recess 50 may be formed such that the opening end 50b and the base 50a have the same shape (such that the depressed-portion forms a columnar space), as shown in FIG. 6. Alternatively, the finger recess 50 may be formed to have an inclined surface 50c that inclines toward the sheet-containment depressed portion as it approaches the base 50a from the opening end side 50b, as shown in FIG. 7. Alternatively, the finger recess 50 may be formed to have a curved surface 50d (such that the finger recess 50 forms a space like the space formed by one fourth of a sphere), as shown in FIG. 8.

The other features are the same as those of the first embodiment including the parts not shown in the drawings, and hence, are designated by the same reference numerals in the drawings and the descriptions that overlap are omitted.

The operation-area indicating sheet 33 of the portable computer 1 of the embodiment is replaced with a new one in the following manner.

First, the operation-area indicating sheet 33 that has been stuck to the base 40a of the sheet-containment depressed portion 40 is peeled off. To do that, put a finger into the finger recess 50 and on the edge of the operation-area indicating sheet 33. Pull the edge of the operation-area indicating sheet 33 toward the side 41b opposite to the side 41a at which the finger recess 50 is provided, and peel off the operation-area indicating sheet 33. The rest of the movements are the same as the replacement movements of the first embodiment. In other words, the user selects a new operation-area indicating sheet 33 having a desired color and pattern and stick it to the base 40a of the sheet-containment depressed portion 40. By the above-described movements, the operation-area indicating sheet 33 can be replaced with a new one.

As described above, the portable computer 1 of the embodiment has a finger recess 50, at a position corresponding to the sheet-containment depressed portion 40 of the outer surface 11a of the housing 10, for allowing a user to put his finger on the edge of the operation-area indicating sheet 33 at the time of peeling off the operation-area indicating sheet 33. Therefore, when replacing the operation-area indicating sheet 33 with a new one, the operation-area indicating sheet 33 can be easily peeled off.

The base 50a of the finger recess 50 is situated at a lower level than the exposed surface 33a of the operation-area indicating sheet 33. Therefore, a user can put his finger on the edge of the operation-area indicating sheet 33.

In the embodiment, an overhang edge portion 43 is omitted; however, both an overhang edge portion 43 and a finger recess 50 may be provided to the housing 10.

The present invention is not limited to the above-described first and second embodiments. The input surface 32a of the pointing device 31 may be on any part of the inner surface 11b of the housing 10, and it is only necessary to provide an operation-area indicating sheet 33 at a position corresponding to at least part of the pointing device 31.

The electronic apparatus of the present invention is not limited to a portable computer, and the present invention is applicable to various electronic apparatuses such as electronic organizer and PDAs.

What is claimed is:

1. An electronic apparatus comprising:
a housing having an outer wall;
a pointing device having a flat input surface and contained in the housing such that the input surface is placed on an inner surface of the outer wall of the housing; and
an operation-area indicating sheet removably provided on an outer surface of the outer wall of the housing at a position corresponding to at least part of the input surface of the pointing device.

2. The electronic apparatus according to claim 1, wherein
the outer surface of the outer wall has a sheet-containment depressed portion at a position corresponding to at least part of the input surface of the pointing device,
the sheet-containment depressed portion has a base and a peripheral surface rising from a perimeter of the base, and
the operation-area indicating sheet is removably stuck to the base of the sheet-containment depressed portion.

3. The electronic apparatus according to claim 1, wherein an exposed surface of the operation-area indicating sheet is different in color from the outer surface of the outer wall.

4. The electronic apparatus according to claim 1, wherein an exposed surface of the operation-area indicating sheet is decorated with a pattern.

5. The electronic apparatus according to claim 1, wherein
the outer surface of the outer wall has a palm rest, and
the operation-area indicating sheet is provided on the palm rest.

6. The electronic apparatus according to claim 2, wherein
the housing has an overhang edge portion at an opening end of the sheet-containment depressed portion, and
the overhang edge portion overhangs to cover at least part of a perimeter portion of the operation-area indicating sheet.

7. The electronic apparatus according to claim 2, wherein the outer surface of the outer wall has a finger recess, at a position corresponding to the sheet-containment depressed portion, for putting a finger on an edge of the operation-area indicating sheet when the operation-area indicating sheet is peeled off.

8. The electronic apparatus according to claim 6, wherein the housing has a frame that fits into the sheet-containment depressed portion along the peripheral surface of the sheet-containment depressed portion, and
the overhang edge portion is provided to the frame.

9. The electronic apparatus according to claim 6, wherein
the base of the sheet-containment depressed portion has four corner portions, and
four overhang edge portions identical to the overhang edge portion are provided at positions corresponding to the four corner portions, respectively.

10. The electronic apparatus according to claim 6, wherein the operation-area indicating sheet is flexible.

11. The electronic apparatus according to claim 7, wherein the base of the sheet-containment depression portion has a side, and the finger recess is provided at a position corresponding to the side.

12. The electronic apparatus according to claim 7, wherein the finger recess has a base situated at a lower level than an exposed surface of the operation-area indicating sheet.

13. The electronic apparatus according to claim 8, wherein
the base of the sheet-containment depressed portion has four corner portions, and
four overhang edge portions identical to the overhang edge portion are provided at positions corresponding to the four corner portions, respectively.

14. The electronic apparatus according to claim 11, wherein the finger recess has a base situated at a lower level than an exposed surface of the operation-area indicating sheet.
